(19) United States
(12) Patent Application Publication
(10) Pub. No.: US 2007/0276933 A1
(43) Pub. Date: Nov. 29, 2007

(54) Providing quality of service to prioritized clients with dynamic capacity reservation within a server cluster

(76) Inventors: Nathan Junsup Lee, New City, NY (US); Krishna C. Ratakonda, Yorktown Heights, NY (US); Deepak Srinivas Turaga, Elmsford, NY (US)

Correspondence Address: F. CHAU & ASSOCIATES, LLC, 130 WOODBURY ROAD, WOODBURY, NY, 11797, US

(21) Appl. No.: 11/440,911

(22) Filed: May 25, 2006

(51) Int. Cl. G06F 15/173

(52) U.S. Cl. 709/223; 709/224

(57) ABSTRACT

A computer-implemented method for delivering a level of quality of service for a client requesting data in a connection arrangement including a server and a plurality of clients assigned one of a plurality of classes, wherein the determination of the level of quality of service includes estimating an arrival rate of potential future requests of at least one class of the plurality of classes, determining a capacity of the at least one data server, determining a current load of the server, reserving a capacity for at least the one class of the plurality of classes according to an estimated arrival rate, assigning the server to the client, and serving the data to the client from an assigned data server, wherein an amount of capacity is allotted to the client according to the level of the quality of service.

### BACKGROUND OF THE INVENTION

1. Technical Field

The present invention relates to networks of processors, and more particularly to a system and method for prioritizing clients with dynamic capacity reservation and a quality of service method thereof.

2. Discussion of Related Art

Quality of service (QoS) corresponds to a goodness or quality with which a certain operation or service may be performed. Services like multimedia applications or a simple phone call need guarantees about accuracy, dependability, and speed of transmission. QoS parameters can be characterized qualitatively in services classes including deterministic QoS used for hard, real-time application, statistical QoS used for soft real-time applications, and best effort QoS where no guarantees are made. Quantitative parameters may include throughput, reliability, delay, and jitter corresponding to the variation delay between a minimum and maximum delay time of a data communication.

In a multimedia system comprising M multimedia servers, each with a capacity Cᵢ 1≦i≦M, a capacity of the system can be measured in terms of the resources available at the server. For example, the capacity in terms of the total bandwidth that the server can support. The system has different video streams that it can serve to each client. Furthermore, each available video stream S has N_{S} representations (e.g., qualities) corresponding to bit-rates R₁<R₂< . . . <R_{N}_{_{S}}. Clients can have P different priorities, where each priority can correspond to a different level of desired service, e.g. Gold, Silver, Bronze, etc., and could correspond to the amount the client is willing to pay to receive the service.

One way to solve this problem of assigning clients servers and representations (bit-rates) is using an exhaustive approach. In this case whenever a new client arrives into the system, all clients are reallocated bandwidths based on their priorities (and possibly moved from one server to another, although this often leads to unacceptable delays and disruptions for clients). However, there are certain limitations of real systems that make it difficult to adopt the optimal approach. These include:

1) Reassignment of different bandwidths to client in the middle of a streaming session is not supported by many current streaming servers, such as Microsoft Media Server etc.

2) Pre-emption of clients is undesirable, wherein clients that are already viewing content should not be abruptly terminated.

Therefore, a need exists for a system and method for prioritizing clients with dynamic bandwidth reservation and a quality of service method thereof.

### SUMMARY OF THE INVENTION

A computer-implemented method for delivering a level of quality of service for a client requesting data in a connection arrangement including at least one data server and a plurality of clients assigned one of a plurality of classes, wherein the determination of the level of quality of service includes estimating an arrival rate of potential future requests of at least one class of the plurality of classes, determining a capacity of the at least one data server, determining a current load of the at least one data server, reserving a capacity for at least the one class of the plurality of classes according to an estimated arrival rate, assigning a data server of the at least one data server to the client, and serving the data to the client from an assigned data server, wherein an amount of capacity is allotted to the client according to the level of the quality of service.

Estimating the arrival rates of the potential future requests includes determining an aggregated average arrival rate of requests, and estimating an expected arrival rate of requests from each class of client. Determining the capacity further includes determining an available amount of capacity of the at least one data server based on a maximum capacity and the current load, and reserving an amount of capacity to serve a class of clients higher than the client based on the expected arrival rate of a higher class.

The assigned data server has a minimum expected session duration among the plurality of data servers.

The method includes determining a hit-rate of the data. The method includes distributing the data across two or more data servers upon determining the hit-rate to be greater than or equal to a threshold.

The method includes comprising determining an expected session duration at the current load.

The method includes determining that the at least one data server has not reached a respective maximum capacity prior to assigning the assigned media server.

According to an embodiment of the present disclosure, a program storage device is provided readable by machine, tangibly embodying a program of instructions executable by the machine to perform method steps for delivering a level of quality of service for a client requesting data from a server cluster including at least one media server. The method steps include estimating an arrival rate of potential future requests of at least one class of the plurality of classes, determining a capacity of the at least one media server, determining a current load of the at least one media server, reserving a capacity for at least the one class of the plurality of classes according to an estimated arrival rate, assigning a media server of the at least one media server to the client, and serving the data to the client from an assigned media server, wherein an amount of capacity is allotted to the client according to the level of the quality of service.

According to an embodiment of the present disclosure, a computer-implemented method for delivering a level of quality of service for client requests for data, wherein the determination of the level of quality of service includes receiving, by a server cluster, a request for the data from a certain client, estimating arrival rates of potential future data requests for a class of clients having a different priority than the certain client, determining a first capacity of each of the plurality of servers, and reserving a second capacity for future data requests from of the class of clients having the different priority. The method further includes allotting a third capacity to the certain client according to the first capacity and the second capacity, assigning the certain client to one of the plurality of servers according to the first capacity, the second capacity, and the third capacity, and serving the data to the certain client from an assigned server.

### BRIEF DESCRIPTION OF THE DRAWINGS

Preferred embodiments of the present disclosure will be described below in more detail, with reference to the accompanying drawings:

FIG. 1 is a diagram of a system according to an embodiment of the present disclosure;

FIG. 2 is a flow chart of a method according to an embodiment of the present disclosure; and

FIG. 3 is a diagram of a system according to an embodiment of the present disclosure.

### DETAILED DESCRIPTION OF PREFERRED EMBODIMENTS

According to an embodiment of the present disclosure, a multimedia system establishes a quality of service (QoS) supported by a system with dynamically arriving and departing clients, while substantially ensuring that clients with higher priorities experience better QoS. This problem differs significantly from web-service clusters because, for example, each request can be serviced at a different quality (video can have different representations), each session lasts for a significantly longer duration (video may be viewed for several minutes/hours) thereby impacting the QoS of future clients, and video streaming is resource intensive.

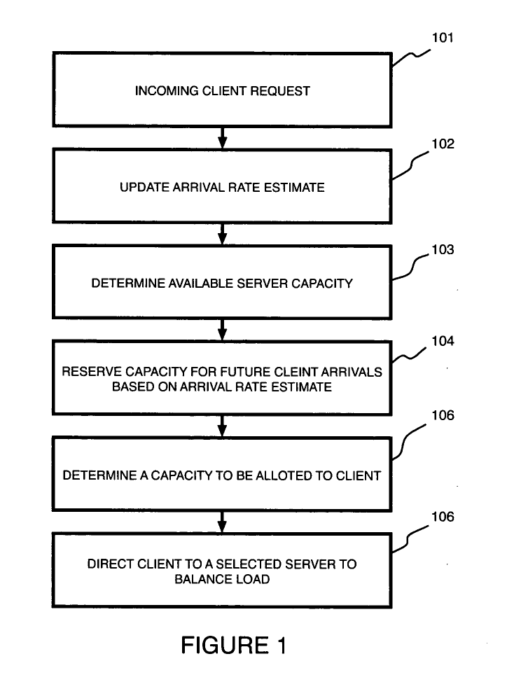

Referring to FIG. 1, a method according to an embodiment of the present disclosure comprises receiving an incoming client request 101 of a given client at a server of a multimedia system. Upon arrival of the request at the server an arrival rate estimate is determined 102, e.g., the rate at which the server is receiving client requests. The available server capacity is determined 103 and capacity is reserved for future arrivals of client requests based on the arrival rate estimate 104. A capacity to be allocated to the given client is determined 105. The given client is served by the server using the allocated capacity 106. In a multimedia system comprising more than one server, the capacity of each of a plurality of servers is determined and one of the plurality of servers is selected to serve the client according to the server capacities and allocated capacity.

While embodiments of the present invention have been described in terms of reserving communication bandwidth, one of ordinary skill in the art would appreciate that other capacities may be reserved, for example, CPU cycles, etc.

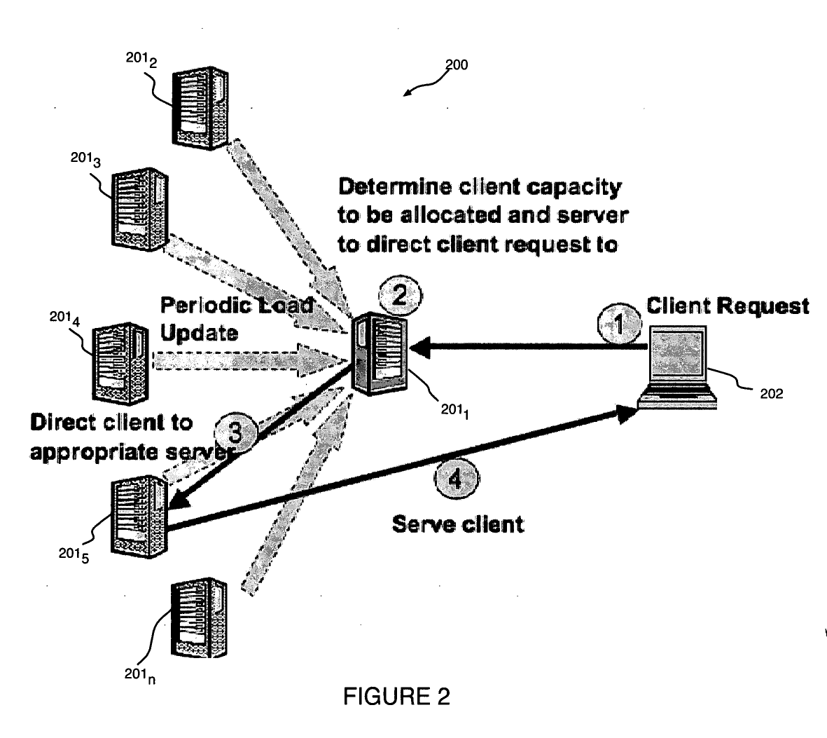

Referring to FIG. 2, embodiments of the present disclosure are described using an exemplary multimedia system 200 comprising M multimedia servers 201₁-201ₙ, each with a capacity Cᵢ 1≦i≦M. The capacity of the multimedia system 200 can be measured in terms of the resources available at a given/selected server e.g., 201₅: for example, the capacity in terms of the total bandwidth that the server 201₅ can support. The system has different video streams that it can serve to each client 202. Furthermore, each available video stream S has N_{S} representations (e.g., qualities) corresponding to bit-rates R₁<R₂< . . . <R_{N}_{_{S}}. Client 202 can have P different priorities, where each priority can correspond to a different level of desired service, e.g., Gold, Silver, Bronze, etc., and can correspond to the amount the client 202 is willing to pay to receive the service.

According to an embodiment of the present disclosure, to substantially ensure better QoS for clients with higher priority, an adaptive resource reservation mechanism is implemented in the system 200. A server 201₅ assigned to the client 202 is not changed during the course of a streaming session, although each client can be allocated a different bandwidth based on the available representations. Parameters of the adaptive resource reservation mechanism include:
1) The arrival rate of the clients. Let clients at priority level p have an arrival rate λₚ. Note that this arrival rate can be estimated on-line, based on collection of real-time statistics.
2) The maximum capacity and load on each server.
3) The hit-rate (popularity) of each streaming asset. Different video assets are likely to have different popularities based on the underlying content. To reduce scenarios with unbalanced loads, content is distributed across the servers such that each server has a similar ratio of total popularity of content to server capacity. It is to be noted that the popularity of the assets may be time varying, and can be estimated online by gathering statistics on the requested stream. The hit-rate may be compared to a threshold to determine whether to distribute content.

One of ordinary skill in the art would appreciate that other parameters may be implemented.

Consider a client with priority p that arrives in the system at time t requesting video stream S; to perform adaptive resource reservation, a time-window is considered over which the reservation needs to be made. The time window can be as long as the duration of the current stream (e.g., expected value, since the user may play, pause or seek within the same stream), or as short as until the arrival of the next client into the system (e.g., expected arrival).

Labeling time window W; note that by changing this time window, the redundancy versus QoS guarantee tradeoff is controlled. If the time window is increased, added redundancy is placed in the system, wherein it is less likely that all available bandwidth will be used. At the same time, this leads to improved guarantees on the quality of service for higher priority clients.

The expected number of clients that arrive in the system in the interval during the interval may be determined as

$${\sum }_{j = 1}^{P} \frac{W}{{λ}_{j}} .$$

When bandwidth is allocated to the current client, it only needs to consider that it does not lead to lowered QoS for clients that have a higher priority than it, that arrive in the system later. The expected number of clients of higher priority that arrive within this interval may be determined as

$${\sum }_{j = p + 1}^{P} \frac{W}{{λ}_{j}} .$$

To guarantee that higher priority clients receive higher quality, a certain bandwidth is reserved for each of these “expected” clients. The amount of reserved bandwidth per client is a parameter that affects the redundancy versus QoS tradeoff. The larger the bandwidth reserved per client, the greater the redundancy, but at the same time providing better QoS guarantees. Consider that an average reserved bandwidth R R₁≦R≦R_{N}_{_{S}} for each of these “expected” clients. Different bandwidths can be reserved for clients belonging to different priority classes, wherein the parameter R is a weighted average. The total bandwidth that is needed to reserve when this client arrives is

$${R}_{p}^{res} = {\sum }_{j = p + 1}^{P} \frac{W}{{λ}_{j}} R .$$

Let the current load on server k be Lₖ(t). The maximum bandwidth that server k can allocate to the client with priority p (given this reservation) for video stream s may be determined as:

$${B}_{p}^{k , s} ( t ) = \{ \begin{matrix}{C}_{k} - {L}_{k} ( t ) - {R}_{p}^{res} ; & if server k has the requested stream s \\ 0 ; & otherwise\end{matrix}$$

Furthermore, to balance the load across the servers, and to improve the quality that the client can receive, clients are assigned to the server with the lowest load. Hence the server m that the client is assigned to may be determined as:

$$\hat{m} = {arg max}_{k} ( {B}_{p}^{k , s} ( t ) )$$

and the bandwidth allotted to the client may be determined as:

\hat{R}=R_{q}, such that R_{q}≦Bₚ^{\hat{m},s}(t)<R_{q+1},

where R₀=0 and R_{N}_{_{S}}₊₁=∞.

In a system comprising one server, the assigned server may be defaulted to the one server.

It is to be understood that the present invention may be implemented in various forms of hardware, software, firmware, special purpose processors, or a combination thereof. In one embodiment, the present invention may be implemented in software as an application program tangibly embodied on a program storage device. The application program, e.g., mark detection software, database software, etc., may be uploaded to, and executed by, a machine comprising any suitable architecture.

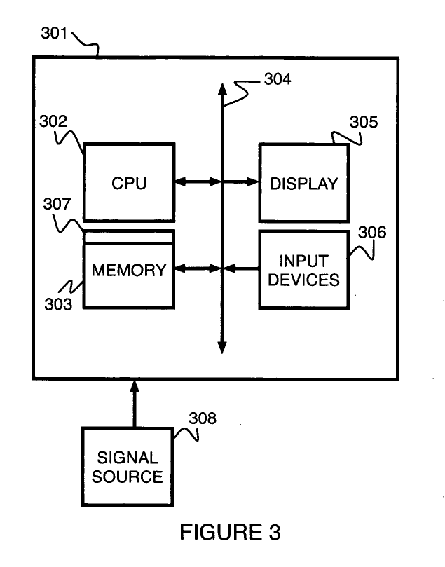

Referring to FIG. 3, according to an embodiment of the present invention, a computer system 301 for prioritizing clients with dynamic bandwidth reservation can comprise, inter alia, a central processing unit (CPU) 302, a memory 303 and an input/output (I/O) interface 304. The computer system 301 is generally coupled through the I/O interface 304 to a display 305 and various input devices 306 such as a mouse and keyboard. The support circuits can include circuits such as cache, power supplies, clock circuits, and a communications bus. The memory 303 can include random access memory (RAM), read only memory (ROM), disk drive, tape drive, etc., or a combination thereof. The present invention can be implemented as a routine 307 that is stored in memory 303 and executed by the CPU 302 to process the signal from the signal source 308. As such, the computer system 301 is a general-purpose computer system that becomes a specific purpose computer system when executing the routine 307 of the present invention.

The computer platform 301 also includes an operating system and micro-instruction code. The various processes and functions described herein may either be part of the micro-instruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Having described embodiments for a system and method for prioritizing clients with dynamic bandwidth reservation and a quality of service method thereof, it is noted that modifications and variations can be made by persons skilled in the art in light of the above teachings. It is therefore to be understood that changes may be made in particular embodiments of the invention disclosed which are within the scope and spirit of the disclosure.

What is claimed is:

1. A computer-implemented method for delivering a level of quality of service for a client requesting data in a connection arrangement including at least one data server and a plurality of clients assigned one of a plurality of classes, wherein the determination of the level of quality of service comprises:
estimating an arrival rate of potential future requests of at least one class of the plurality of classes;
determining a capacity of the at least one data server;
determining a current load of the at least one data server;
reserving a capacity for at least the one class of the plurality of classes according to an estimated arrival rate;
assigning a data server of the at least one data server to the client; and
serving the data to the client from an assigned data server, wherein an amount of capacity is allotted to the client according to the level of the quality of service.

2. The computer-implemented method of claim 1, wherein estimating the arrival rates of the potential future requests comprises:
determining an aggregated average arrival rate of requests; and
estimating an expected arrival rate of requests from each class of client.

3. The computer-implemented method of claim 1, wherein determining the capacity further comprises:
determining an available amount of capacity of the at least one data server based on a maximum capacity and the current load; and
reserving an amount of capacity to serve a class of clients higher than the client based on the expected arrival rate of a higher class.

4. The computer-implemented method of claim 1, wherein the assigned data server has a minimum expected session duration among the plurality of data servers.

5. The computer-implemented method of claim 1, further comprising determining a hit-rate of the data.

6. The computer-implemented method of claim 5, further comprising distributing the data across two or more data servers upon determining the hit-rate to be greater than or equal to a threshold.

7. The computer-implemented method of claim 1, further comprising determining an expected session duration at the current load.

8. The computer-implemented method of claim 1, further comprising determining that the at least one data server has not reached a respective maximum capacity prior to assigning the assigned media server.

9. A program storage device readable by machine, tangibly embodying a program of instructions executable by the machine to perform method steps for delivering a level of quality of service for a client requesting data from a server cluster including at least one media server, the method steps comprising:
estimating an arrival rate of potential future requests of at least one class of the plurality of classes;
determining a capacity of the at least one media server;
determining a current load of the at least one media server;
reserving a capacity for at least the one class of the plurality of classes according to an estimated arrival rate;
assigning a media server of the at least one media server to the client; and
serving the data to the client from an assigned media server, wherein an amount of capacity is allotted to the client according to the level of the quality of service.

10. The method of claim 9, wherein estimating the arrival rates of the potential future requests comprises:
determining an aggregated average arrival rate of requests; and
estimating an expected arrival rate of requests from each class of client.

11. The method of claim 9, wherein determining the capacity further comprises:
determining an available amount of capacity of the at least one media server based on a maximum capacity and the current load; and
reserving an amount of capacity to serve a class of clients higher than the client based on the expected arrival rate of a higher class.

12. The method of claim 9, wherein the assigned media server has a minimum expected session duration among the plurality of media servers.

13. The method of claim 9, further comprising determining a hit-rate of the data.

14. The method of claim 13, further comprising distributing the data across two or more media servers upon determining the hit-rate to be greater than or equal to a threshold.

15. The method of claim 9, further comprising determining an expected session duration at the current load.

16. The method of claim 9, further comprising determining that the at least one media server has not reached a respective maximum capacity prior to assigning the assigned media server.

17. A computer-implemented method for delivering a level of quality of service for client requests for data, wherein the determination of the level of quality of service comprises:
receiving, by a server cluster, a request for the data from a certain client;
estimating arrival rates of potential future data requests for a class of clients having a different priority than the certain client;
determining a first capacity of each of the plurality of servers;
reserving a second capacity for future data requests from of the class of clients having the different priority;
allotting a third capacity to the certain client according to the first capacity and the second capacity;
assigning the certain client to one of the plurality of servers according to the first capacity, the second capacity, and the third capacity; and
serving the data to the certain client from an assigned server.

18. The computer-implemented method of claim 17, further comprising determining an expected session duration for each of the plurality of servers having sufficient first capacity to support the second capacity and the third capacity, wherein the assigned server has a minimum expected session duration among the plurality of servers having sufficient first capacity to support the second capacity and the third capacity.
